(19) United States
(12) Patent Application Publication
(10) Pub. No.: US 2021/0223622 A1
(43) Pub. Date: Jul. 22, 2021

(54) DISPLAY DEVICE

(71) Applicant: Japan Display Inc., Tokyo (JP)

(72) Inventors: Yoichi KAMIJO, Tokyo (JP); Yoshikatsu IMAZEKI, Tokyo (JP); Shuichi OSAWA, Tokyo (JP); Yoshihiro WATANABE, Tokyo (JP); Koichi MIYASAKA, Tokyo (JP)

(21) Appl. No.: 17/221,330

(22) Filed: Apr. 2, 2021

Related U.S. Application Data
(63) Continuation of application No. PCT/JP2019/033387, filed on Aug. 26, 2019.

(30) Foreign Application Priority Data
Oct. 2, 2018 (JP) 2018-187554

(51) Int. Cl. G02F 1/13357; G02F 1/1333

(52) U.S. Cl. CPC G02F 1/133602; G02F 1/133305

(57) ABSTRACT

According to one embodiment, a display device includes a display panel comprising a first substrate, a second substrate opposing the first substrate, and a first cutout portion cut in each of the first substrate and the second substrate and a flexible substrate comprising a bent portion which is bent and mounted on a mounting portion located in the first cutout portion, and the bent portion passes through the first cutout portion.

### CROSS-REFERENCE TO RELATED APPLICATIONS

This application is a Continuation Application of PCT Application No. PCT/JP2019/033387, filed Aug. 26, 2019 and based upon and claiming the benefit of priority from Japanese Patent Application No. 2018-187554, filed Oct. 2, 2018, the entire contents of all of which are incorporated herein by reference.

### FIELD

Embodiments described herein relate generally to a display device.

### BACKGROUND

Recently, there is a demand of narrowing a frame of display devices in order to downsize the display device or to expand the display area which displays images. In particular, for mobile devices such as smartphones, there is an increasing demand of narrowing the frame. For example, one end of a flexible printed circuit board (FPC) is joined to a display panel. This FPC is expanded outward from the display panel, and then bent to, for example, a bottom surface side of the case of the back light.

### BRIEF DESCRIPTION OF THE DRAWINGS

FIG. 1 is a plan view showing a display device of an embodiment.

FIG. 2 is an exploded perspective view showing a configuration example of the display device shown in FIG. 1.

FIG. 3 is a plan view showing a display panel and a flexible substrate of this embodiment.

FIG. 4 is a cross-sectional view of the display device taken along line A-B shown in FIG. 3.

FIG. 5 is a plan view of the display device of this embodiment as viewed from a back light side.

FIG. 6 is a plan view of the display device of this embodiment as viewed from a back light side.

FIG. 7 is a cross-sectional view of the display device taken along line C-D shown in FIG. 6.

FIG. 8 is a plan view showing a mounting portion and its surroundings of the first substrate.

### DETAILED DESCRIPTION

In general, according to one embodiment, a display device comprises a display panel comprising a first substrate, a second substrate opposing the first substrate, and a first cutout portion cut in each of the first substrate and the second substrate and a flexible substrate comprising a bent portion which is bent and mounted on a mounting portion located in the first cutout portion, and the bent portion passes through the first cutout portion.

According to another embodiment, a display device comprises a display panel comprising a first substrate, a second substrate opposing the first substrate and a first cutout portion cut in each of the first substrate and the second substrate, and the first substrate is exposed from the second substrate in the first cutout portion.

Embodiments will be described hereinafter with reference to the accompanying drawings. The disclosure is a mere example, and arbitrary change of gist which can be easily conceived by a person of ordinary skill in the art naturally falls within the inventive scope. To more clarify the explanations, the drawings may pictorially show width, thickness, shape and the like, of each portion as compared with an actual aspect, but they are mere examples and do not restrict the interpretation of the invention. In the present specification and drawings, elements like or similar to those in the already described drawings may be denoted by similar reference numbers and their detailed descriptions may be arbitrarily omitted.

The main configuration of this embodiment can be used for display devices and the like. The display devices can be used for, for example, various devices such as smartphones, tablet terminals, mobile telephone terminals, notebook computers, vehicle-mounted devices, and game consoles. The embodiments can be applied to liquid crystal display devices, self-luminous display devices such as organic electroluminescent display devices, electronic paper display devices comprising an electrophoretic element and the like, display devices employing micro-electromechanical systems (MEMS) and display devices employing electrochromism.

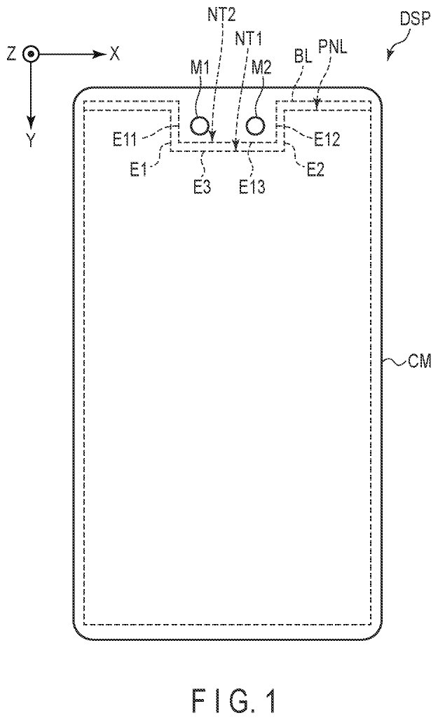

FIG. 1 is a plan view showing a display device DSP according to an embodiment.

For example, a first direction X, a second direction Y and a third direction Z are orthogonal to each other, but may intersect at an angle other than ninety degrees. The first direction X and the second direction Y correspond to directions parallel to a main surface of a substrate which constitutes the display device DSP, and the third direction Z corresponds to a thickness direction of the display device DSP.

In the following descriptions, a direction forwarding a tip of an arrow indicating the third direction Z is referred to as “upward” and a direction forwarding oppositely from the tip of the arrow is referred to as “downward”. With such expressions “a second member above a first member” and “a second member below a first member”, the second member may be in contact with the first member or may be remote from the first member.

The display device DSP comprises a display panel PNL, a backlight BL, and a cover member CM. The display panel PNL comprises a first notch portion NT1 (which may be referred to as a first cutout portion NT1 as well). The first notch portion NT1 comprises a first edge E1 and a second edge E2 extending along the second direction Y and a third edge E3 extending along the first direction X and connected to the first edge E1 and the second edge E2. The backlight BL overlaps the display panel PNL along the third direction Z and irradiates light on the display panel PNL. Further, the backlight BL comprises a second notch portion NT2 (to be referred to also as a second cutout portion NT2) at a position overlapping the first notch portion NT1. The second notch portion NT2 comprises a first edge E11 and a second edge E12 extending along the second direction Y and a third edge E13 extending along the first direction X and connected to the first edge E11 and the second edge E12. In the example illustrated, the first notch portions NT1 and the second notch portion NT2 are different from each other in size, but they may be the same as each other. The first edges E1 and E11 may overlap each other, the second edges E2 and E12 may overlap each other, and the third edges E3 and E13 may overlap each other.

The display device DSP comprises modules M1 and M2 accommodated in the first notch portion NT1 and the second notch portion NT2, respectively. The modules M1 and M2 are arranged along the first direction X in the first notch portion NT1 and the second notch portion NT2, respectively. The modules M1 and M2 are, for example, a camera and a loud speaker. Note that a proximity sensor, an optical sensor, a microphone and the like may be disposed in the first notch portion NT1 and the second notch portion NT2.

The cover member CM overlaps the display panel PNL, the backlight BL, and the modules M1 and M2. Further, the cover member CM covers the first notch portion NT1 and the second notch portion NT2.

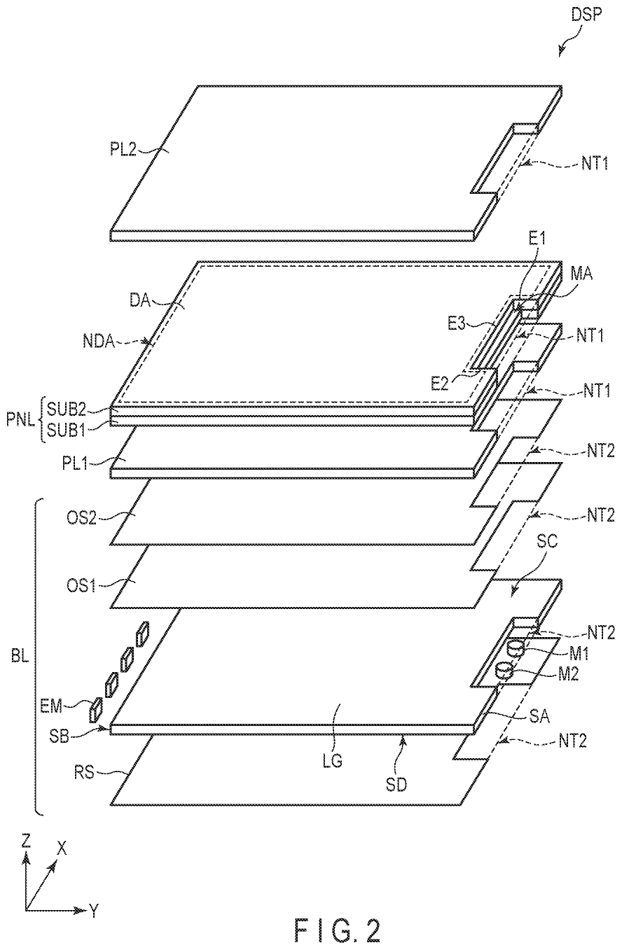

FIG. 2 is an exploded perspective view showing a configuration example of the display device DSP shown in FIG. 1.

The display device DSP comprises a display panel PNL, a first polarizer PL1, a second polarizer PL2 and a backlight BL.

The display panel PNL is formed into a flat plate shape parallel to an X-Y plane. The display panel PNL comprises a first substrate SUB1, and a second substrate SUB2 opposing the first substrate SUB1. The first notch portion NT1 is a cutout portion formed in the first substrate SUB1 and the second substrate SUB2. The first substrate SUB1 includes a mounting portion MA exposed from the second substrate SUB2 in the first notch portion NT1. The display panel PNL includes a display area DA which displays images and a frame-shaped non-display area NDA surrounding the display area DA.

The detailed structure of the display panel PNL will be omitted here, but the display panel PNL may be provided for any of a display mode which uses a lateral electric field along a main surface of the substrate, a display mode which uses a longitudinal electric field along a normal to the main surface of the substrate, and a display mode which uses an inclined electric field with respect to a direction inclined to the main surface of the substrate, and also a display mode which uses the lateral electric field, the longitudinal electric field and the inclined electric field in combination. The main surface of the substrate is a surface parallel to the X-Y plane defined by the first direction X and the second direction Y.

The first polarizer PL1 is located under the display panel PNL. The second polarizer PL2 is located above the display panel PNL. That is, the display panel PNL is located between the first polarizer PL1 and the second polarizer PL2. The first polarizer PL1 and the second polarizer PL2 are placed to overlap at least the display area DA with respect to the display panel PNL. The first notch portion NT1 is also formed in the first polarizer PL1 and the second polarizer PL2.

The backlight BL comprises a reflective sheet RS, a light guide LG, a light source EM, an optical sheet OS1 and an optical sheet OS2. The reflective sheet RS, the light guide LG, the optical sheets OS1 and OS2, the first polarizer PL1, the display panel PNL and the second polarizer PL2 are arranged in this order along the third direction Z.

The light guide LG comprises a first side surface SA, a second side surface SB on an opposite side to the first side surface SA, a main surface SC on a display panel PNL side, a main surface SD on an opposite side to the main surface SC and a second notch portion NT2. The second notch portion NT2 is formed in the first side surface SA.

The optical sheets OS1 and OS2 are located between the light guide LG and the display panel PNL. The optical sheet OS1 opposes the main surface SC of the light guide LG The optical sheet OS2 opposes a lower surface of the first polarizer PL1. The second notch portion NT2 of the backlight BL is formed in the optical sheets OS1 and OS2 as well. The optical sheets OS1 and OS2 are, for example, a prism sheet and diffusion sheet. In the example illustrated, the backlight BL comprise two optical sheets, but it may comprise one or three or more optical sheets.

The reflective sheet RS opposes the main surface SD. In other words, the light guide LG is located between the reflective sheet RS and the optical sheet OS1. The second notch portion NT2 of the backlight BL is formed in the reflective sheet RS as well. The reflective sheet RS may be fixed to, for example, a metal-made case. In this case, the second notch portion NT2 may be provided in the case as well.

A plurality of light sources EM are arranged along the first direction X with intervals respectively therebetween. In the example illustrated, the light sources EM oppose the second side surface SB of the light guide LG The light sources EM are, for example, light-emitting diodes (LEDs) and emit white illumination light. The illumination light emitted from the light sources EM enters from the second side surface SB, and proceeds along the direction of the arrow indicating the second direction Y. The illumination light guided by the light guide LG is emitted towards the display panel PNL from the main surface SC and illuminates the display panel PNL. The display panel PNL, the first polarizer PL1 and the second polarizer PL2 display images on the display area DA by selectively transmitting the illumination light. Note that, as the light sources EM, light-emitting diodes of different emission colors such as red, blue, green and the like may be arranged side by side.

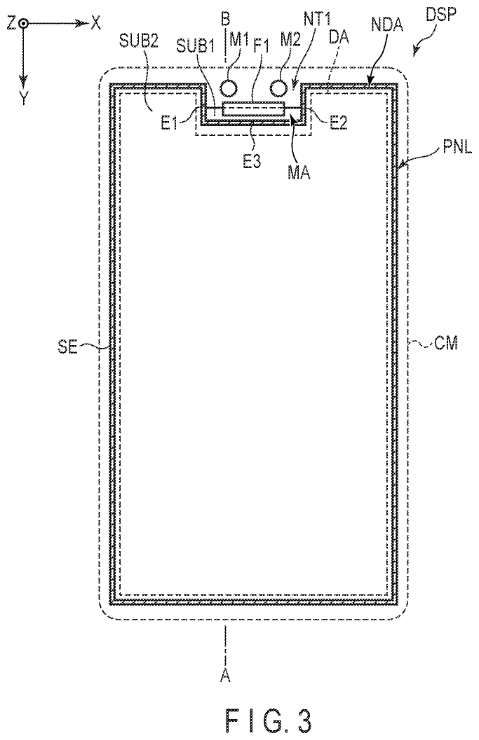

FIG. 3 is a plan view showing the display panel PNL and a flexible substrate F1 of this embodiment.

The display device DSP further comprises the flexible substrate F1 mounted on the mounting portion MA located in the first notch portion NT1. The flexible substrate F1 is located on the first substrate SUB1 and electrically connected to the display panel PNL. A width of the flexible substrate F1 along the first direction X is less than a width of the first notch portion NT1 along the first direction X, but they may be substantially equal to each other. The flexible substrate F1 is flexible and is bent on a rear surface side of the display panel PNL, as will be described later. The modules M1 and M2 located respectively in the first notch portion NT1 and the second notch portion NT2 may be connected to the flexible substrate F1. Further, the display area DA extends to both sides of the first notch portion NT1 along the first direction X.

The first substrate SUB1 and the second substrate SUB2 are attached to each other via a sealant SE. The sealant SE is located in the non-display area NDA. The sealant SE is located along the first edge E1, the second edge E2 and the third edge E3 in the first notch portion NT1. The mounting portion MA is located on an outer side of the sealant SE.

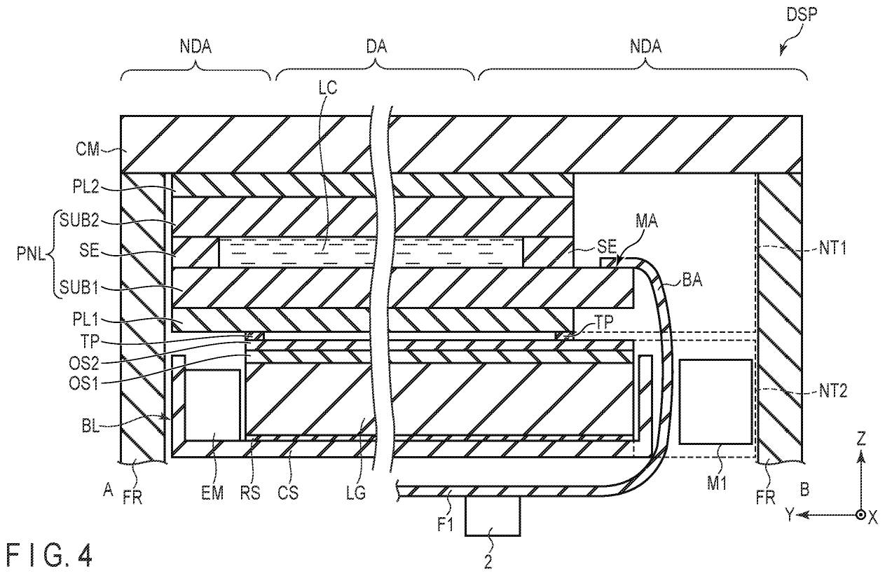

FIG. 4 is a cross-sectional view of the display device DSP taken along line A-B shown in FIG. 3.

The display panel PNL comprises a first substrate SUB1, a second substrate SUB2 and a liquid crystal layer LC sealed by the sealant SE. The first polarizer PL1 is adhered to the first substrate SUB1. The second polarizer PL2 is adhered to the second substrate SUB2.

The optical sheets OS1 and OS2, the light guide LG, the reflective sheet RS and the light sources EM are accommodated in the case CS. The optical sheet OS2 is attached to the first polarizer PL1 by a tape TP. A frame FR is fixed to the cover member CM and surrounds the display panel PNL and the backlight BL.

The flexible substrate F1 is bent to the rear surface of the backlight BL. The flexible substrate F1 comprises a bent portion BA which is bent. The bent portion BA passes through the first notch portion NT1 and the second notch portion NT2. Further, the bent portion BA passes between the module M1 and the backlight BL. The IC chip 2 is located on a surface of the bent flexible substrate F1 on an opposite side to a surface opposing the backlight BL.

According to this embodiment, the flexible substrate F1 is mounted on the mounting portion MA located in the first notch portion NT1. Further, the bent portion BA of the flexible substrate F1 passes through the first notch portion NT1 and the second notch portion NT2. By repulsion of the bending, the bent portion BA swells towards the outer side of the display panel PNL along the second direction Y. But the flexible substrate F1 is mounted on the first notch portion NT1, and therefore the bent portion BA does not protrude from the first notch portion NT1 along the second direction Y. Therefore, the increase in the width of frame of the display device DSP, caused by the swelling of the bent portion BA can be suppressed. Thus, the frame of the display device DSP can be narrowed.

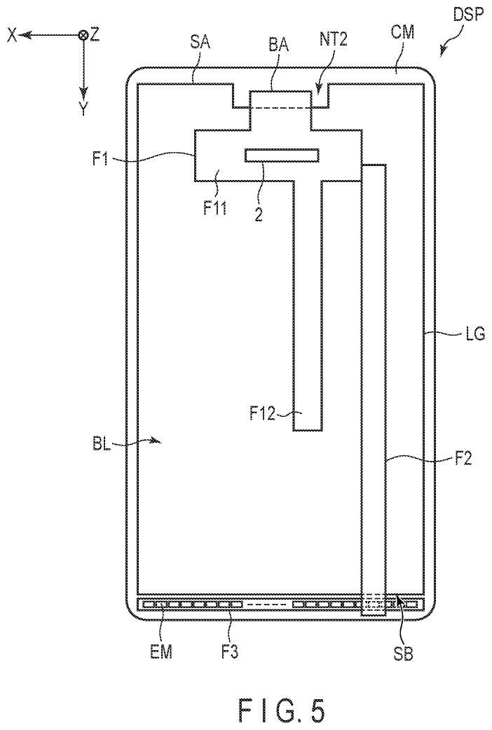

FIG. 5 is a plan view of the display device DSP of this embodiment as viewed from a backlight BL side.

The flexible substrate F1 includes a main body portion F11 and an extending portion F12 extending from the main body portion F11 in the second direction Y. A width of the main body portion F11 along the first direction X is greater than a width of the bent portion BA along the first direction X. The IC chip 2 is mounted on the main body portion F11. The extending portion F12 is connected to, for example, a drive unit of the display device DSP.

In the example illustrated, the light sources EM are arranged along the second side surface SB. The light sources EM are disposed on the flexible substrate F3. The flexible substrate F3 is disposed along the second side surface SB and extends out along the first direction X. The flexible substrate F3 is connected to the flexible substrate F2, folded back on the rear surface side of the backlight BL, and extends along the second direction Y. The flexible substrate F2 is connected to the flexible substrate F1 using a connector or the like.

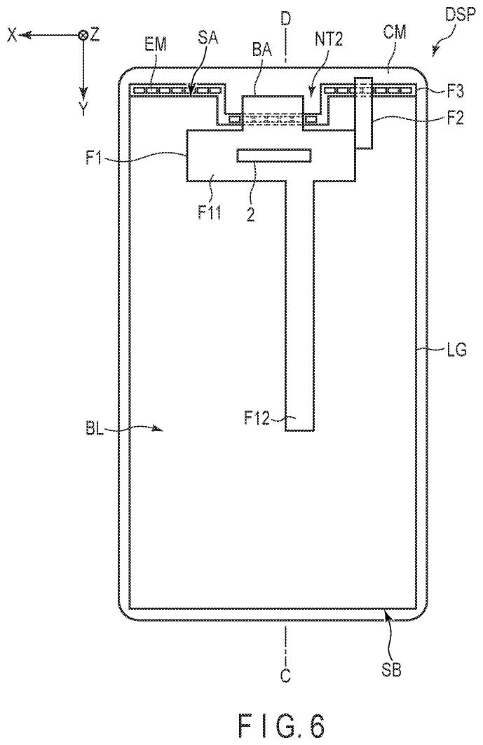

FIG. 6 is a plan view of the display device DSP of this embodiment as viewed from a backlight BL side.

In the example illustrated, the light sources EM are arranged along the first side surface SA. The light sources EM are disposed on the flexible substrate F3. The flexible substrate F3 is disposed along the first side surface SA. That is, the flexible substrate F3 has a shape bent from the first side surface SA to the second side surface SB side. The flexible substrate F3 is connected to the flexible substrate F2, and folded back on the rear surface side of the backlight BL and extends along the second direction Y. The flexible substrate F2 is connected to the flexible substrate F1 using a connector or the like.

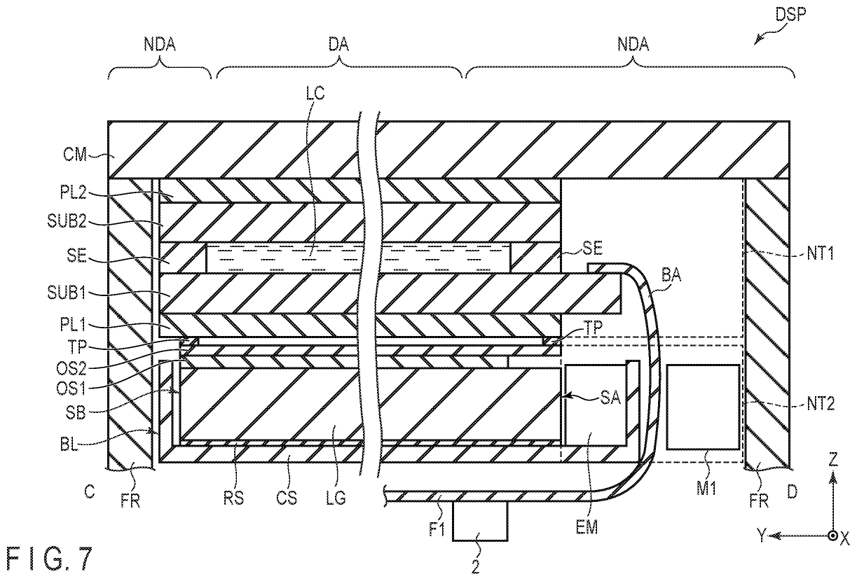

FIG. 7 is a cross-sectional view of the display device DSP taken along line C-D shown in FIG. 6. The configuration shown in FIG. 7 is different from that of FIG. 4 in that the light sources EM oppose the first side surface SA.

The light sources EM are located between the bent portion BA of the flexible substrate F1 and the light guide LG With the structure that the light sources EM are located on the first side surface SA side, the space for placing a light source EM on the second side surface SB side can be reduced, thereby making it possible to narrow the frame of the display device DSP on the second side surface SB side.

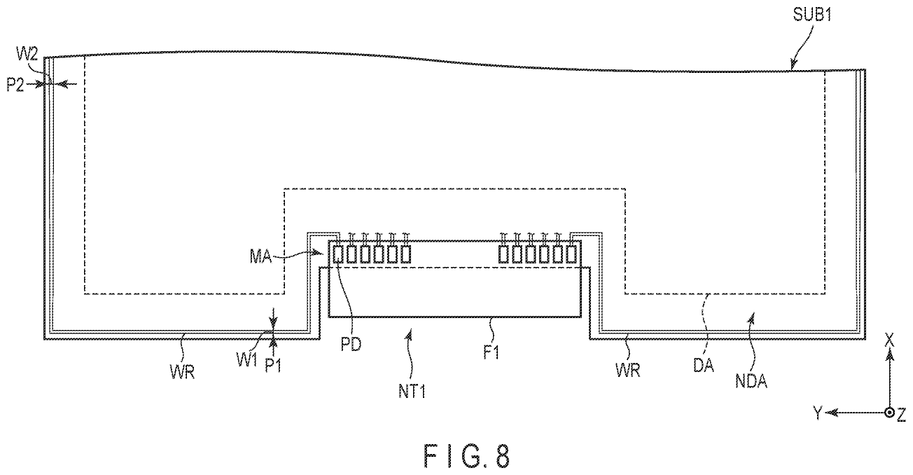

FIG. 8 is a plan view showing the mounting portion MA of the first substrate SUB1 and its surroundings.

The first substrate SUB1 comprises a plurality of pads PD in the mounting portion MA. The pads PD are arranged along the first direction X. Further, the first substrate SUB1 comprise wiring lines WR connected to the pads PD, respectively. In the example illustrated, the wiring lines WR are routed around the non-display area NDA along the shape of the first notch portion NT1. The wiring lines WR each increase its line width or thickness, for example, as further away from the pads PD. That is, at a position P1 and a position P2 remote more from the pads PD than from the position P1, a width W2 of a wiring line WR at the position P2 is greater than a width W1 of the wiring line WR at the position P1. Or, a thickness of a wiring line WR at the position P2 is greater than a thickness of the wiring line WR at the position P1. Thus, as further remote away from the pads PD, a resistance value of the wiring line WR can be lowered.

Note that this embodiment is described in connection with a liquid crystal display device as an example of the display device DSP, but the embodiment is not limited to this. As the display device DSP, an organic EL display device may be used. The organic EL display device is self-illuminous and therefore a backlight may not be provided.

As described above, according to this embodiment, a display device with a narrowed frame can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Examples of the display device which can be obtained from the configurations described in the present specification will be hereinafter explained.

(1) A display device comprising:

a display panel comprising a first substrate, a second substrate opposing the first substrate, and a first cutout portion cut in each of the first substrate and the second substrate; and

a flexible substrate comprising a bent portion which is bent and mounted on a mounting portion located in the first cutout portion, wherein

the bent portion passes through the first cutout portion.

(2) The display device of item (1), wherein

the first substrate comprises the mounting portion exposed from the second substrate in the first cutout portion.

(3) The display device of item (1), further comprising:

a backlight which illuminates the display panel,

wherein

the backlight comprises a second cutout portion overlapping the first cutout portion, and a light guide comprising a first side surface where the second cutout portion is located and a second side surface on an opposite side to the first side surface, and

the bent portion passes through the second cutout portion.

(4) The display device of item (3), wherein

the back light further comprises a light source disposed along the first side surface.

(5) The display device of item (3), wherein

the backlight further comprises a light source disposed along the second side surface.

(6) The display device of item (1), wherein

the display panel comprises a display area which displays images and a non-display area surrounding the display area, and

the display area extends to both sides of the first cutout portion.

(7) The display device of item (1), further comprising a module accommodated in the first cutout portion.

(8) A display device comprising:

a display panel comprising a first substrate, a second substrate opposing the first substrate, and a first cutout portion cut in each of the first substrate and the second substrate,

wherein

the first substrate is exposed from the second substrate in the first cutout portion.

(9) The display device of item (8), further comprising:

a flexible substrate comprising a bent portion which is bent and mounted in a mounting portion located in the first cutout portion; and

a backlight which illuminates the display panel,

wherein

the backlight comprises a second cutout portion overlapping the first cutout portion, and a light guide comprising a first side surface where the second cutout portion is located and a second side surface on an opposite side to the first side surface, and

the bent portion passes through the first cutout portion and the second cutout portion.

(10) The display device of item (9), wherein

the backlight further comprises a light source disposed along the first side surface.

(11) The display device of item (9), wherein

the backlight further comprises a light source disposed along the second side surface.

(12) The display device of item (8), wherein

the display panel comprises a display area which displays images and a non-display area surrounding the display area, and

the display area extends to both sides of the first cutout portion.

(13) The display device of item (8), further comprising a module accommodated in the first cutout portion.

What is claimed is:

1. A display device comprising:
a display panel comprising a first substrate, a second substrate opposing the first substrate, and a first cutout portion cut in each of the first substrate and the second substrate; and
a flexible substrate comprising a bent portion which is bent and mounted on a mounting portion located in the first cutout portion, wherein
the bent portion passes through the first cutout portion.

2. The display device of claim 1, wherein
the first substrate comprises the mounting portion exposed from the second substrate in the first cutout portion.

3. The display device of claim 1, further comprising:
a backlight which illuminates the display panel,
wherein
the backlight comprises a second cutout portion overlapping the first cutout portion, and a light guide comprising a first side surface where the second cutout portion is located and a second side surface on an opposite side to the first side surface, and
the bent portion passes through the second cutout portion.

4. The display device of claim 3, wherein
the back light further comprises a light source disposed along the first side surface.

5. The display device of claim 3, wherein
the backlight further comprises a light source disposed along the second side surface.

6. The display device of claim 1, wherein
the display panel comprises a display area which displays images and a non-display area surrounding the display area, and
the display area extends to both sides of the first cutout portion.

7. The display device of claim 1, further comprising a module accommodated in the first cutout portion.

8. A display device comprising:
a display panel comprising a first substrate, a second substrate opposing the first substrate, and a first cutout portion cut in each of the first substrate and the second substrate,
wherein
the first substrate is exposed from the second substrate in the first cutout portion.

9. The display device of claim 8, further comprising:
a flexible substrate comprising a bent portion which is bent and mounted in a mounting portion located in the first cutout portion; and
a backlight which illuminates the display panel,
wherein
the backlight comprises a second cutout portion overlapping the first cutout portion, and a light guide comprising a first side surface where the second cutout portion is located and a second side surface on an opposite side to the first side surface, and
the bent portion passes through the first cutout portion and the second cutout portion.

10. The display device of claim 9, wherein
the backlight further comprises a light source disposed along the first side surface.

11. The display device of claim 9, wherein
the backlight further comprises a light source disposed along the second side surface.

12. The display device of claim 8, wherein
the display panel comprises a display area which displays images and a non-display area surrounding the display area, and
the display area extends to both sides of the first cutout portion.

13. The display device of claim 8, further comprising a module accommodated in the first cutout portion.
